(19) United States
(12) Patent Application Publication
(10) Pub. No.: US 2013/0211959 A1
(43) Pub. Date: Aug. 15, 2013

(54) System to Maximize Regional Regulated Revenue

(71) Applicants: Randall W. MARUSYK, Ottawa (CA); Paramjit S. GILL, Ottawa (CA)

(72) Inventors: Randall W. MARUSYK, Ottawa (CA); Paramjit S. GILL, Ottawa (CA)

(21) Appl. No.: 13/766,272

(22) Filed: Feb. 13, 2013

Related U.S. Application Data
(60) Provisional application No. 61/598,195, filed on Feb. 13, 2012.

(51) Int. Cl. G06Q 30/06

(52) U.S. Cl. CPC G06Q 30/0607
USPC 705/26.25

(57) ABSTRACT

The present invention provides a system and method for a vehicular regionally regulated electronic platform allowing for a plurality of users to interface with said platform to effect various regulatory services, such as parking. The platform may also be used by enforcement authorities to implement enforcement regimes with increased efficiency and maximizing revenue.

### FIELD OF THE INVENTION

The present invention pertains to the field of electronic regulatory systems and in particular to methods of enhancing regulatory revenue.

### BACKGROUND

Current regulatory systems in place allow residents to accomplish a variety of independent regional related tasks such as renewing vehicle licensing, purchasing a public transportation pass, and paying for parking.

The problem with such systems is that the integration of said systems are not harmonized and furthermore do not have a singular focus of providing said services while being optimized to generate revenue.

Furthermore, the enforcement for contravention of these said services remains an inefficient problem and utilizes tremendous regional regulatory resources for compliance of regional regulated services.

For example, the issuance of parking tickets once a meter has expired is a long established tradition of a race to the vehicle by either the owner, hoping to beat the parking ticket issuer to the automobile thus avoiding the issuance of a parking ticket, and the parking ticket issuer to the automobile in order to issue a ticket.

As technology improved, the ticket issuer could rely on coin feed parking meters that accurately reflected the time that the automobile owner paid for at the time of parking. This system typically involved the parking ticket issuer walking or driving by the parking meters and checking as to whether the parking meter still has remaining bought time on the meter (and is therefore legally parked) or whether the automobile owner is illegally parked because the meter has expired or was possibly never engaged. Once the ticket issuer determines that the meter has expired (or was never engaged) the ticket issuer issues a ticket. The ticket issuer generally makes patrols of a designated route without any real time information in relation to parking spaces along the route to determine whether various vehicles are in contravention of parking infractions.

Various techniques have been traditionally used by parking ticket issuers, such as tire marking to determine the duration, at least, of an automobile that has been parked in a given parking space. If the ticketing issuer returns to the vehicle with the marked tire, and there is no evidence of movement of the car, the ticket issuer issues a ticket.

More recently, parking technology has evolved to include smart meters, or pay stations, and sensors. Such systems are typically driven by photovoltaic cells which provide power and sensors that can sense whether a car is parked in a space or not. Yet other such systems require an identified parking space that the parking permission payment is associated with and the payment is made for a specific space and the parking permit is issued for the specific space for a set time period. The parking ticket issuer must still physically visit the various parking spaces to determine whether a car is in a location and whether the automobile owner has purchased the correct ticket.

Therefore there is a need for a more efficient system of optimizing revenue gains from various regional regulatory services.

In one aspect of the presently claimed invention allows, over the existing systems, an ability to bring an increased efficiency and number of parking tickets for the issuing entity, such as a city or municipality and minimizing the chance of a missed expired meter or the possibility of the owner (or a good Samaritan) making it back to the meter before the ticket issuer can issue a ticket. It also provides an improvement over the collection of outstanding parking tickets or other fines in a more efficient and cost effective manner.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system to maximize regional regulated revenue. In accordance with an aspect of the present invention, there is provided a system for a vehicular regionally regulated electronic platform comprising: a plurality of users which interface with the system for various vehicular regionally regulated services; one or more vehicular regional regulatory servers configured to allow one or more users to login, authenticate, and execute selected one or more services based on perquisite verification with said platform; one or more vehicular regional regulatory databases configured to analyze parameters for said one or more vehicular regionally regulated services input from the one or more users to correctly administer selected services; and an interface to a communication means allowing for communication between said plurality of users and the one or more vehicular regional regulatory servers and one or more vehicular regional databases.

In accordance with another aspect of the present invention, there is provided a system for a maximizing vehicular regionally regulated parking revenue comprising: a plurality of users and enforcement agents which interface with the system for various vehicular regionally regulated services; one or more vehicular regional regulatory servers configured to allow one or more users and enforcement agents to login, authenticate, and execute selected one or more parking services based on perquisite verification with said platform; one or more vehicular regional regulatory databases configured to analyze parameters for said one or more vehicular regionally regulated parking services input from the one or more users to correctly administer said services, wherein one parameter is user location; and an interface to a communication means allowing for communication between said plurality of users, said plurality of enforcement agents, the one or more vehicular regional regulatory servers and one or more vehicular regional databases.

In accordance with another aspect of the present invention, there is provided a method for a user of a vehicular regionally regulated electronic platform to select a service comprising the following steps: sending user information to facilitate logon and authenticate to said platform; selecting one or more services available on said platform; accessing one or more vehicular regional regulatory databases for verification and availability of services; and executing the selected service on said platform.

In accordance with yet another aspect of the present invention, there is provided a method for a vehicular regionally regulated electronic platform to facilitate a service comprising the following steps: receiving user information to facilitate logon and authentication to said platform from the plurality of users; providing one or more services available on said platform to the plurality of users; providing one or more vehicular regional regulatory databases to the plurality of users for verification and availability of services; and executing the selected service on said platform for the plurality of users.

### DETAILED DESCRIPTION OF THE INVENTION

### Definitions

The term “user” is defined as any individual utilizing the electronic platform. The user may be the end customer, the regional regulatory authority, or a third party user of the electronic platform.

The term “regional regulatory authority” is defined as any party which determines the regulatory services of a region and authorizes enforcement of the same. The authority may be a public party such as a level of government (e.g., county, city, state, provincial, federal, etc.) or a private party such as an assigned task force dedicated to a regulatory service.

Unless defined otherwise, all technical and scientific terms used herein have the same meaning as commonly understood by one of ordinary skill in the art to which this invention belongs.

An object of the present invention is to provide a system to maximize regional regulated revenue. In accordance with an aspect of the present invention, there is provided a system and method for a vehicular regionally regulated electronic platform allowing for a plurality of users to interface with said platform to effect various regulatory services, such as parking. The platform may also be used by enforcement authorities to implement enforcement regimes with increased efficiency.

### System Configuration

The system is implemented utilizing an electronic platform for harmonizing all regional regulatory services. The platform may be of any network topology with the implementation allowing for users to interact with the regulatory regime and transact for a service (even if service does not require payment). The platform is accessible from a multitude of electronic devices including, but not limited to, parking meters, smart parking meters, government multi-functional kiosks, mobile phones, mobile tablets, personal computers, personal data assistants, gaming consoles, televisions, internal vehicle information systems with graphical user interfaces, vehicle internal computers with graphical user interface, other similar vehicular type information systems, and any built-in internet capable device.

In certain embodiments, the topology is entirely encapsulated within regional regulatory servers and operations are enabled through internet based interface. The platform may be accessed online through any capable internet browser client. In this embodiment, there is no need for local installation; rather all features of said platform would be available online through any device, such as for example cloud computing based topology.

In certain embodiments, the topology requires a downloadable application to be installed on the user's device. The platform may be installed locally on electronic devices by retrieving a software package. The software package may be retrieved by conventions means such as download or physical hardware including, but not limited to, optical media and memory drives.

In certain embodiments, a hybrid approach is employed where a downloadable application is utilized on the user electronic device; however larger databases are utilized by the regional regulatory servers. In this embodiment, the operations of the platform may be split based on pre-determined criteria, selected by the regional regulatory authority, with respect to various operations of the platform.

The system includes one or more regulatory services which allow for the one or more users to login and authenticate securely. The system also includes one or more electronic databases configured to store the relevant parameters of the one or more vehicular regionally regulated services selected by the one or more users. The system also utilizes an interface to a communication means allowing the users to interface through hardware and software with the other system elements, including the regulatory servers and databases. The communications means itself would be understood by a worker skilled in the art to include any necessary elements of hardware, including but not limited to communications ports, wireless transmitter/receivers, wires or fibre optics; and software, including but not limited to telephony, e-mail, facsimile, Bluetooth.®., TCP/IP, FTP, XML, IRC, and the like, that allow a computing device to exchange data packets with another computing device.

In certain embodiments, the platform provides for a secure authentication allowing for users to identify and authenticate with regulatory servers confirming their identity. This authentication may be accomplished by a variety of known methods including, but not limited to, username/password, biometrics (e.g., fingerprint, retina, voice), near-field communication, electronic protocols (e.g. Bluetooth, DLNA), usage of official personal identification (e.g., driver's license, health card, social insurance, vehicle license plate, any other issued government identification).

Once the user is authenticated with the electronic platform, the user may interact and perform any number of regional regulatory services within said region. The location of the user may be shared with the platform such that the platform may allocate the corresponding services available within said region to the user and furthermore inform said user of any respective updates for various available services. In a preferred embodiment, the authentication process requires the usage of official identification to verify the identity of the individual such that any contravention or attempted fraudulent behavior may be tracked to an official identification of a user.

In certain embodiments, whenever the user wishes to utilize a service of the platform, the user authenticates with the service, which may be done for example by a smartphone, and is then given the corresponding information required to select an available service. Once the service is selected, the system will effect any required administration electronically and allow said user to continue with the transaction of the service having been entirely completed.

In certain embodiments, if the user of the system is non-regional (e.g. they are from a different country), the user may apply for a temporary electronic platform pass which allows for logon/logoff with a payment method on the account. In other embodiments, a pre-defined amount will be stored initially prior to use and refunded when the temporary pass expires. The temporary pass may consist of a card for legacy hardware, a user account for electronic operation, or any like combination thereof. The user will be required to submit an official piece of identification from their residence (non-regional) to create an account with the electronic platform. The official user non-regional information will be stored securely in the electronic platform database. The use of such information may be required to enforce reciprocal enforcement agreements between regions for identification purposes.

In certain embodiments, the system works harmoniously with legacy regulatory service infrastructure to reduce the administration involved with said services but integrating and automating this administration in the platform to reduce resources (e.g., time, personnel) for the regional regulatory authorities.

In certain embodiments, the system functions independently and self-sufficiently such that all regional regulatory services may be implemented through the electronic platform.

In certain embodiments, the hardware provided to share location is embedded within the vehicle such that the vehicle can always transmit and receive communication with the regional regulatory service. The service may synchronize with known services to provide location status such as OnStar®, vehicular GPS, and the like.

### Parking Application

In certain embodiments, the system utilizes the electronic platform to enhance the monetary return from regulated parking within a region.

In certain embodiments, the regional regulatory authority will be the administrator of the platform enabling residents of the region to utilize the platform for various parking related services.

### Platform System Implementation

In certain embodiments, the electronic platform will be the sole mode of interacting with the regional regulatory authorities regarding parking.

A resident wishing to use the platform for parking relating service may login to the service using any known login mechanism known in the art, including but not limited to, username/password, biometrics (e.g., fingerprint, retina, voice), usage of official personal identification (e.g., driver's license, health card, license plate, social insurance number, any other issued government identification).

Prior to first use, the user registers with the platform, which may be controlled by the regional regulatory authority, to create an account such that all future use can be quickly effected by the login credentials mentioned above. Registration of an account can be implemented as known in the art and includes usage of official information to verify and authenticate that the individual registering is indeed said individual.

Subsequent to the login stage, the user will authenticate with regional regulatory authority servers to verify status of account and address any potential limitations to account usage. Limitations may include any outstanding infractions of the system, including but not limited to, outstanding parking fines, suspended driver's license, expired driver's license, outstanding traffic violations, outstanding regulatory fines, any other vehicular related infraction, or any infraction legally affiliated with a vehicular violation infraction. For example, in certain embodiments, a user may login to find that a parking ticket is outstanding on their account and must be paid in full prior to future usage of any services connected to the platform. Restrictions on the account and potential penalties/consequences may be controlled by the regional regulatory authority.

Subsequent to the authentication stage, and assuming the user is permitted to advance to the next stage, the user can select a service on the platform. Any number of services may be posted on the platform by the regional regulatory authority. In the parking embodiment the services may include, but are not limited to, paying for a selected parking space, reserving parking, querying system for parking rate, querying system for parking availability during various durations, reserving a parking space, auctioning a parking space, amongst other similar types of parking related services.

Subsequent to the selection stage, a corresponding database will be checked with respect to the selected service to ensure the correct parameters are configured to allow for the user to effect the selected service. For example, if the user has selected to reserve parking, the corresponding database must be checked to verify whether the parking is available for the proposed time and that it is not in conflict with another user or some specialized event which impacts the reservation of parking for the street. The database maintains all information of the plurality of users in the system. The database integrates legacy infrastructure such as parking meters, smart meters, parking sensors, and kiosks as well as all information purely from remote access users. The database ensures real time accuracy as the information is immediately updated to allow for a better user experience.

Once the service is selected and the database is checked, assuming the checks are completed as outlined in the previous steps, the service will be executed allowing the user to perform whichever service is selected. This results in an input into the corresponding database of the user data.

In certain embodiments, an additional step may be implemented such that the status of said selected service is reported to one or more parties. The parties may include the user, the regional regulatory authority, and third parties including public display (e.g., website).

### Specific Embodiments For Parking Application

In certain embodiments, a user utilizes the platform to pay for parking. The user finds a vacant parking space and proceeds to park on the space. The user then accesses the platform from one of a variety of means.

In certain embodiments, the user utilizes the application of the platform designed specifically for the vehicle specific interior information management system wherein the user utilizes the user interface of the display within their own vehicle to login, share the vehicle's location, authenticate, and select paid parking at current location.

At this stage the user can select the method of payment. In certain embodiments, the proposed duration may be selected. In certain embodiments, a timer may be initiated whereby the user is billed once the user stops said timer. A further measure may be put in place wherein the user may face a penalty if the user still remains in said parking space after a defined period after the timer has been disengaged. In other embodiments, the user may engage a location based mechanism such that the device remains active tracking the user's movements after the user has parked such that the user can share their location of the parking space to define this location as the location where the vehicle is parked. A timer is started after this service is selected, and tracks the user moving from this location and disengages the timer once the user returns based on the user's location provided by their mobile device. In this embodiment, most operations are automated resulting in minimal use of the platform by the user. In another embodiment, the user may utilize a parking meter, smart meter, or kiosk to login with the system. The user may login by any of the means mentioned previously including but not limited to, username/password, near-field-communication, input of license plate, and scanning of official identification. In another embodiment, the user may utilize a parking meter, smart meter, or kiosk to login with the system, and the meter will provide a parking stub to be placed in the vehicle as visual confirmation of service purchase. The platform may be configured such that the user cannot purchase services from the parking meter without paying previous outstanding infractions. Payment may be effected by utilizing the parking meter by suitable means (e.g., credit card, debit, etc.) or by paying using a user's electronic device which may also have financial modes of payment pre-loaded with their account (e.g., credit card or smart phone payments system). The electronic means of payment may use conventional third party mediums such as PayPal® or Apple iTunes®.

Once the parking is selected, the selected parking service is matched to the corresponding database populated by users of the platform and the regional regulatory authority to ensure that parking on the selected space is permissible. If the space is not permissible the user will be notified on the mobile device or at the pay station during the selection process. If the selected space is permissible the user is sent a confirmatory message during the selection process such that the user is assured said service selected is legitimate with the regional regulatory authority.

### Parking Monetization Methods

The parking monetization with respect to parking and all aspects of parking are controlled by the regional regulatory authority. Various methods may be implemented with respect to the platform in order to maximize regulatory based revenues on parking.

In certain embodiments, the rate of parking may be responsive to an interval assessment of the occupancy of each individual parking space. If the occupancy was greater than the previous interval the price may fluctuate upward by a pre-defined rate such that the parking space will increase with demand of said space. Conversely, if occupancy of a parking space is less than the previous interval value, the parking space decreases by a pre-defined rate. There may be a pre-defined maximum, minimum and starting rate which is at the discretion of the regional regulatory authority. It can be seen in such an embodiment, that the authorities may maximize return from the higher occupancy spaces, and may also promote increase occupancy of lower priced parking spaces.

In certain embodiments, the user may reserve a parking space using the platform. In this scenario the user would login to the platform remotely (e.g., using a laptop computer), or at a legacy pay station, and access the database to verify a certain parking space is available at a specified time. If the parking space is available, the platform will inform the user that the space is available. The user may be given two options: to select and reserve the parking space at a nominal pre-determined value which guarantees the space to the user provided that the space is not out-bided by another user. For example, this option may be useful when searching for parking in an urban center and quickly reserving the space knowing that it may take a nominal period (e.g., less than five minutes) to physically access the space. This is known as a “soft-reservation”. The second option is that the user may guarantee the reserved parking space with a higher price allowing for no bidding on said parking space and is known as a “hard-reservation”. This may have utility in situations where a special event is planned and the user wishes to guarantee availability for a specified time, and thus is willing to pay a premium to ensure said availability. It can be seen in such an embodiment that the authorities may maximize return from the higher occupancy spaces. A further tier of reservation may be obtained wherein an enforcement agent may verify the selected reserved parking space is vacant by physical verification prior to and upon commencement of the reservation selected time period. If a third party is occupying said space, the enforcement officer may tow the vehicle or execute any other permissible resolution to the infraction. The user will pay a premium for this service to ensure the parking space will be vacant.

In certain embodiments, certain parking spaces may be selected by the regional regulatory authority as being part of an auction based pricing method whereby the parking rate may be selectively set based on specific timing per day and additionally be subject to an auction system whereby users may bid on a parking space for a specific time. The auction would close at a pre-determined time prior to said time the parking space is being bid for. In this fashion users have the ability to pre-plan their stay and ensure accommodation for their vehicle far in advance.

In certain embodiments, various third party parking services may be listed on the platform such that various parking rates including the regional regulatory authority as well as third party rates. These rates may be compared and provided together with location, availability, and price. In this way the user may be able to make a calculated decision with respect to which parking space to select ahead of time. Furthermore, these listings would be updated in real-time and ensure a high level of accuracy.

In certain embodiments, the various third party parking services may be listed on the platform in a reverse-auction type of pricing scheme such that users may query the platform to reserve a specific parking space within a defined region and at a specific time allowing the various third parties and regional regulatory authority to bid for the space within the region wherein the lowest price at the end of a defined interval will be selected as the service for the user. The third parties may be required to pay a fee to the regional regulatory authority in order to be listed on the platform.

In certain embodiments, the platform will provide for the regional regulatory authority to enforce third party private parking lots with regional regulatory enforcement agents. In this way, a private parking need not have parking attendants or staff; rather the user of said private parking will login to the electronic platform and utilize said platform as a gateway to pay the rates set by the third party while enforcement and monitoring of the third party lot is conducted by the regional regulatory officer. It this embodiment, the regional regulatory authority is given a pre-defined rate of revenues accruing from enforcement of the third party parking lot.

In certain embodiments, when a parking duration expires for a user, an increased rate may be implemented until the user pays the outstanding balance. This scheme may have a pre-defined upper limit.

In certain embodiments, certain types of infractions which results in a fine may be configured such that late fees may implement a surcharge based on the amount of time past the initial expiry date.

In certain embodiments, the regional regulatory authority or government body may charge the state or province a surcharge for carrying out this platform for the defined region. In this way, the region may generate a further revenue stream from the platform.

### Additional Parking Application Features

Various features may be implemented by the platform to communicate and interface with user regarding all aspects of the status of the service selected. Communication is done through the platform which may include, but is not limited to, parking meters/smart-meters/kiosks, mobile devices, email, instant messaging, SMS, MMS, cellular communication, and data based communication. In certain embodiments, the user has the option of communicating with other users of the platform. This communication may be enabled or disabled depending on each user's permission settings as to allow communications from the one or more other users, rather than solely the regional regulatory authority. Communication with other users must be enabled to have access to further embodiments reliant on the inter-communication between users.

For example, in certain embodiments, if the parking service is selected for a limited duration and is about to expire, a status of the parking time remaining may be communicated to the user (for example by email). The user may extend their parking service, assuming the system allows for this selected service for this user, and remotely pay for the extended duration of said parking space. Payment may be effected by utilizing the parking meter by suitable means (e.g., credit card, debit, etc.) or by paying using a user's electronic device which may also have financial modes of payment pre-loaded with their account (e.g., credit card).

In other embodiments, the platform may alert the user that another user is trying to reserve the parking space for a specific time which overlaps a portion of the current user's space for which the current user has a legitimate space. If the current user, currently occupying the space, would like to accommodate the other user looking to reserve, the current user may receive a pre-determined refund on said space paid by the other user looking to reserve the said parking space. The option is left to the current user to decide how to proceed. In another embodiment, the other user can message the current user with escalating bids to allow for vacancy of the space. This allows for the other user to reserve the said parking space with a more incentivized price. In both embodiments mentioned, a portion of the “re-sale” of the parking space is kept by the regional regulatory authority.

In another embodiment, the platform may inform the user of outstanding infractions prior, during, or after usage of a selected service.

### Enforcement Applications

The platform allows for a more efficient mechanism for enforcement agents to maximize revenue of parking related infractions by utilizing the real time updated data of the platform to target their efforts in areas which result in an increased probability of enforcement, and secondly by scaling the resources of the agents to that of required application.

In certain embodiments, the user is given notification by the platform once the user is in contravention of a certain parking infraction. This notice may be utilized by the regional regulatory authority or law enforcement authorities as evidentiary proof that notice was given to the alleged offender (e.g., user).

The enforcement agents may be any entity which is responsible for the enforcement of the parking infractions. The enforcement agents are given customized access to the platform given their role to monitor and gain access to various data not available to the plurality of users. In some embodiments, the agents are the regional regulatory authority.

In certain embodiments, the enforcement agents may utilize the platform to monitor areas within the region. They may look for target areas which have the highest number of pending expiring tickets. In these embodiments, the enforcement agents may have a targeted approach to enforcement to better allocate their resources. For example in certain instances patrol cars may be directed to a certain area of the region to ensure a higher rate of infraction enforcement.

In other embodiments, the enforcement agents receive notifications that a user's parking term is about to expire. The about to expire notification may be input into a known algorithm for calculating the optimal route in a GPS navigation system to effect the highest probability of issuing infractions. The platform may include live traffic information into algorithm to determine the best route for the enforcement agent.

In other embodiments, the enforcement agent's routes are updated with further real-time information such that the route adjusts its current calculation with additional real-time information to re-optimize. In this fashion, the agents are not driving in defined patrol routes but rather receive updated routes based on the updated platform aggregate database populated by the plurality of users. The database is agnostic to legacy or new platform usage as all information of both is utilized in the population of the database.

Legacy infrastructure of parking enforcement contains parking meters, smart meters, and kiosks. These types of hardware are typically coin-operated or credit card operated wherein the user selects the parking space and pays the projected duration of parking and places a stub on the vehicle dash such that an enforcement agent can routinely make patrols to verify the vehicles are in compliance with parking law. In one embodiment, the legacy infrastructure is updated such that the user can login with their login credentials such that the system is updated regarding the user's location and duration selected for the specific parking space. In this fashion, the enforcement agent need not make patrols to verify whether the user is in compliance with the selected duration, but rather the platform informs the enforcement agent of a pending expiry.

In certain embodiments, the enforcement agent may not be required to physically verify and place an infraction on the physical vehicle in contravention of the parking rules. Instead the platform may issue said infractions in an automated fashion wherein the infraction is added to the user's account. In certain embodiments, the user may no longer use the system until the issued infraction is attended to and complied with, such that the user's record returns to an acceptable status. In another embodiment the user may continue to use the system however the infraction may increase if not complied with (e.g., non-payment of issued fine).

In certain embodiments, the enforcement agents may be utilized in combination with any of the embodiments above to carry out actions which must be done by physical agents. For example, if the system requires a user to be subject to towing or wheel clamping or sending other law enforcement officers to the site for further law enforcement services.

In other embodiments, the platform may be utilized to determine if any user is in contravention of various no-parking zones including, but not limited to, handicapped spaces, school-bus zones, fire-lanes, reserved parking, or other time limited privileged parking. In other embodiments, if the platform determines the user did not actively log-in to park, yet the user's location is in a restricted zone, this information will be relayed to the platform and consequently to the enforcement agents. In another embodiment, the platform works with legacy vehicle sensors on parking spaces to determine whether a vehicle has parked on a restricted space. Security cameras, motion sensors, light sensors, Infrared sensors, Heat sensors or any other type of recognition mechanism may be utilized as information prompts for the electronic database. If such sensors are triggered, an enforcement officer may be notified from the platform to investigate based on the reported cause (e.g., motion sensor was triggered for an unoccupied parking space). The sensor information may be corroborated with other types of information stored in the database to make a decision with higher chance of accuracy. If the user has not authenticated with the platform, the platform will notify the enforcement agents to take action.

In certain embodiments, the services of the platform may not be utilized without all prior infractions being paid. Furthermore, even services which are of no charge require accessing the system to input their location and utilization of parking space. In this fashion, the problem of long standing parking fees is mitigated.

In other embodiments, the platform is utilized to monitor the occupancy of each parking space. The frequency of occupancy is recorded and maintained in the regional regulatory databases. This information may be used to observe inconsistencies with respect to occupancy trends. For example, if one parking space is occupied 4 to 5 times per day and there has been no occupancy in said parking space relative to other parking spaces beside that said parking space, a notification will be sent from the platform to an enforcement agent to investigate whether there is an obstruction or a person illegally utilized said space. In this fashion, parking metrics may be utilized to assist enforcement agents.

In certain embodiments, the platform receives information from parking sensors to determine whether a user is parking in said space or whether said space is vacant. In this fashion, the platform populated the database with user occupancy information based on parking sensor feedback.

In certain embodiments, the enforcement agents may receive reports from a user that a parking space listed as vacant is filled. In this scenario the enforcement officer can access the database to verify correct occupancy status and determine a course of action as to whether the current behavior is legitimate or an enforcement measure should be taken (e.g., ticketing, towing, clamping).

### Regional Vehicle Related Services Application

In another aspect of the invention the platform may be utilized for regional vehicle related services. This platform may be utilized by both the user and the agents of the administration of vehicle services.

In certain embodiments, the user may utilize the platform to automate a large portion of administrative services with the administration authority including, but not limited to, renewing their vehicle license, renewing their vehicle plates, filing for various vehicle permits, applying for interval validation stickers, among any other administrative tasks with the administration authority. While some of the tasks mentioned previously include a physical mailing of certain wares, the entire administrative aspect is effected through the platform.

In certain embodiments, the user may receive electronic versions of any or all of the required identification/verification documents required by an official administration authority. As such the user must be able to provide said information to the law enforcement agents by means of an electronic device within login capability provided that the law enforcement agents recognize the platform as sufficient evidence of vehicle administration. In another embodiment, the law enforcement agents will utilize an electronic device to monitor various users to verify their status of good standing with respect to various vehicle administration aspects. In this fashion, revenue is increased as the system will notify the enforcement officers that various administrative aspects are in contravention and action may be taken.

For example, it is common practice for a law enforcement officer to issue a 48 hour deadline for an expired driver's license to make the driver renew their driver's license which will lead to a suspension of the license as well as a fine if the renewal is not achieved. This function can be largely shifted to the platform whereby for example a parking meter will inform the user of the expiration and the need to renew in 48 hours or suspension will occur, and act as the evidentiary basis for a subsequent fine for failure to renew, and/or allow or disallow the user to obtain any further service with the platform including the parking stub or electronic permission to park based on the parking authorities regulations or policies on this issue.

In certain embodiments, the platform is utilized by the regional regulatory authority to send out notifications of various regional services. For example, the authority (e.g., the municipality) may send out advance notifications of various services including, but not limited to, snow removal services, street sweeping services, hydro related services, or any other services which require some action for public vehicles. In another embodiment, if the vehicles do not comply with the request to move said vehicle for a service, enforcement agents will be summoned to remove the car from the vicinity which may or may not carry an additional penalty.

In certain embodiments, the platform allows for a regional service transportation identification to be purchased through the platform wherein the user's identity is confirmed and payment is credited to the user's account. In this sense, the regional transportation pass may be used for the region's various transportation mediums which may include, but are not limited to, subway, bus, train, light rail, high speed trains, taxis, regional owned bicycles, regional owned automobiles, regional owned motorcycles, and other similar regional owned vehicles.

In certain embodiments, the user may be required to enter the vehicle's license plate number to ensure that it matches with the driver's license to ensure that the vehicle is not stolen or reported missing, and if so, contact the car owner or law enforcement. The exact location of the vehicle can be supplied to the appropriate person (e.g., owner, law enforcement, etc.) to take the appropriate action.

In other embodiments, the platform is used by law enforcement to verify and enforce restraining orders (civil—such as ex-spousal, or criminal—such as pedophile near an elementary school) by informing an individual that should not be near such a location to leave. The platform may further notify individuals such as ex-spouses or school principal that a restraining order is potentially in breach or is about to be breached. Furthermore, the platform may alert law enforcement agents that an individual is in contravention of the restraining order for potential deployment.

### Advertisement Application

The system is structured such that advertisement modules may be encapsulated within the infrastructure on all types of embodiments whether the configuration involves a hybrid legacy and electronic platform approach, or the purely electronic platform approach.

The advertisement may be of the regional regulatory authority or any third party advertisement.

In certain embodiments, advertisement is implemented in the hybrid legacy electronic platform approach. The hardware including parking meters, smart meters, and/or kiosks are programmed to enable an advertisement at the hardware. The hardware has the ability for the meter to generate further revenue through the sale of advertisement whereby the issuance of a parking stub results in an advertisement on a video screen or some other delivery vehicle whether visual, auditory or kinesthetic, while the stub is being printed or even on the stub itself.

In other embodiments, the advertisement is implemented in the purely electronic platform approach. Advertisement may be displayed on the user's electronic device during usage of the platform application or interface to select services. In some embodiments, advertisements are only implemented during loading or processing phases of the application/interface.

In In certain embodiments, participation of the user in active advertisements may reduce infraction costs. In one embodiment if the user participates in an active type of advertisement (e.g., a survey), depending of the type of infraction, the infraction may be reduced by a pre-defined amount. Similarly, in another embodiment, the user could choose whether or not to have the advertisement occur prior to the issuance of the stub in exchange for a partial or full reduction of the parking fees.

In other embodiments, the initial payment or extension of time payment of a user paid using the platform (e.g., over a phone, PDA, internet, or the like) could have a similar advertisement placed before, during or after the payment process.

Yet as a further alternative, other embodiments could have a parking stub of the present system have coupons on the face or back of the stub for promotions, discounts and the like. The platform may utilize location of the user to advertise location specific targeted advertising. For example, a parking space in front of a Starbucks® coffee shop location could generate a coupon for a coffee shop within the area directing the user (via a map or directions) to a competitor of Starbucks® coffee shop.

In certain embodiments, the advertisements may be available for display through the platform prior to utilization of platform services allowing the user to view promotions or advertisements prior to selecting a parking space. In this fashion the user may be able to select parking based on currently held promotions or advertisements based in park upon the products/services being advertised.

The invention will now be described with reference to specific examples. It will be understood that the following examples are intended to describe embodiments of the invention and are not intended to limit the invention in any way.

### EXAMPLES

### Example 1

This example provides an illustration of a user utilizing the electronic platform for conventional parking purposes.

The user wishes to park in the city for an hour and finds a vacant parking space and enters this said vacant parking space. The user uses his mobile smartphone to interface with the electronic platform. The user's location is shared with the platform allowing the platform to determine precisely which parking space the user is occupying. The platform populates the database with the new user information such that the database is aware that this current user is parking in the said parking space at said location. The user selects the duration of 1 hour which is also stored in the aggregate platform database.

The user then attends to his activities in the city when he is alerted by the platform (after configured the mobile application to provide alerts) that his parking space has 10 minutes until expiry. The platform provides an option to “top-up” the account. The user finishes his activities and returns to his vehicle without incurring further costs.

### Example 2

This example provides an illustration of a how enforcement agents utilize the platform to optimize their routes to increase collections on parking infractions.

The enforcement agents logon to the platform to monitor the region for which they are responsible for with respect to enforcement. The platform provides information of all users of the system and pending expiry durations for all users. The platform then calculates the highest percentage of pending expiry in a certain sub-area of the region and alerts the enforcement agents of the same.

In this fashion, the enforcement agents only commute to these sub-areas based on the platform information to obtain the highest probability of issuing parking infractions. Therefore there is no patrolling of regions, as the platform is continually monitoring the region through user input into the platform (storing in the real-time updated databases).

The enforcement agent uses a tablet device in his vehicle while they drive to the sub-area and issue parking tickets. While on his route, the platform informs him that the route is changed due to real-time information updates from the platform databases. This changes the route based on another group of users slated to have their parking expire in real time to inform and navigate the enforcement agent to a revised area which has the highest probability of issuing infractions.

### Example 3

This example provides an illustration of a how a user can use the reservation embodiment to reserve parking using the electronic platform.

The user wishes to celebrate the 4^{th} of July in downtown Washington D.C. However, generally on July 4^{th} the parking on a celebrated day is very difficult to obtain. The user uses the reservation system to reserve the July 4^{th} parking in front of her favorite restaurant. The price of the parking space is regulated by the regional regulatory authority and a premium is put on for July 4^{th}. Furthermore, a reservation adds a further premium to purchasing a reservation for said space.

Nevertheless, the user is determined to make the day special and pays the increased charges through the electronic platform using her tablet computer which has her credit card information pre-loaded. The user has verified by checking the platform for occupancy of parking spaces and saw that her preferred parking space was unoccupied on the specific time and date of her preference.

In this way, the user can be assured that her reservation will be maintained during a likely busy period in Washington D.C.

### Example 4

This example provides an illustration of a how a user can use the reservation embodiment to reserve parking using the electronic platform.

A user is driving around a city center having a difficult time looking for parking. His passenger logs on to the electronic platform using his mobile phone and searches for available parking nearby given his current location. The platform provides a number of options nearby. The passenger puts in a “soft-reservation” for the a space which is 3 minutes away from their current location thinking that they should be able to get to that space in time before a conventional driver who upon parking on said space will be notified by the platform that there is a pending reservation. The passenger pays the required premium for the soft-reservation and does not reserve the spot out-right using the “hard-reservation” which is at an increased premium. The rationale of 3 minutes was a calculated risk on behalf of the passenger.

However, a second user sees that the parking space is unoccupied although there is a soft-reservation made on said space. The second user places a “hard-reservation” on said parking space, paying the increased premium, prior to the first user occupying the space.

The passenger is sent a notification that the parking space is now unavailable as another user has guaranteed the reservation immediately.

### Example 5

This example provides an illustration of a how the reverse auction embodiment is implemented.

A user wishes for parking within 1 block of their doctor's appointment. The user selects the reverse auction selection using their personal computer at home. The user sees that there are 3 private companies and the regional city parking spaces available. The user selects that they wish for a parking space within a specific city block on the platform, and confirmation is required by 1 hour prior to the appointment. The user is given alerts through the platform that one of the private companies has won the reverse auction and gives the user a preferred rate of parking.

The user has the confirmation of this rate of their mobile phone and utilizes this at the preferred parking space.

### Example 6

This example provides an illustration of a how the enforcement agencies allow for collections to occur prior to further use.

A user wishes for parking in a suburb. The parking in the suburb is free. The user must login to the platform to utilize any regional parking, even though the parking is of no charge. The user does not have any electronic device with him, therefore he uses the legacy parking meter to login using official identification; namely scanning his driver's license. The platform authenticates the user and checks for previous outstanding infractions. The user is found to have 2 unpaid parking tickets on his account.

The platform restricts the user from using any further services without first paying any unpaid infractions. Therefore, in this example, even though the service sought is free, the user is restricted from interfacing with the platform making use of the service legitimate without rectifying their previous balance.

### Example 7

This example provides an illustration of a how the advertisement modules of the platform may be implemented.

A user may park in the city to enjoy a sunny day downtown. She authenticates and shares her location with the platform using her tablet to confirm the parking purchase for the selected space. Her past infractions are clear and no reservations had been made on said spot therefore, she is available to park for the listed charge. The user selects to pay per minute rather than a projected estimate.

During the payment process the user is prompted to take part in a survey by a local pizza restaurant in order to reduce parking by $1.00. The user agrees to conduct the survey and receives the $1.00 discount on the total of said parking fee.

### Example 8

This example provides another illustration of a how the advertisement modules of the platform may be implemented.

A user may parks near a hospital to visit a recovering family member. The user authenticates and selects payment for the space he is occupying via his mobile phone. The user is subjected to a located based advertisement stating users who paid for parking are eligible for free coffee with purchase of a muffin at the coffee shop directly in front of the parking lot.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A system for a vehicular regionally regulated electronic platform comprising:
a plurality of users which interface with the system for various vehicular regionally regulated services;
one or more vehicular regional regulatory servers configured to allow one or more users to login, authenticate, and execute selected one or more services based on perquisite verification with said platform;
one or more vehicular regional regulatory databases configured to analyze parameters for said one or more vehicular regionally regulated services input from the one or more users to correctly administer selected services; and
an interface to a communication means allowing for communication between said plurality of users and the one or more vehicular regional regulatory servers and one or more vehicular regional databases.

2. A system of claim 1 wherein one or more vehicular regional regulatory databases are populated by the plurality of users utilizing services on said platform.

3. A system of claim 1 wherein one parameter utilized by the one or more vehicular regional regulatory databases is user location.

4. A system of claim 1 wherein the system is further configured, in a parking service embodiment, to implement a monitored interval assessment of aggregate parking occupancy for a region and adjusts set rates of parking spaces based on occupancy rate, wherein the parking rate for the one or more users increases by a pre-defined amount when the occupancy, measured against a previous interval, increases, and parking rate for one or more users decreases by a pre-defined amount when the occupancy, measured as a previous interval, decreases.

5. A system of claim 1 wherein the system is configured, in a parking service embodiment, to reserve a parking space for one or more users upon the selection of a parking space at a specific time selected by a user in exchange for a pre-defined charge to the user.

6. A system of claim 1 wherein the system is configured, in a parking embodiment, to allow one or more users to bid on the price of a parking space up to a pre-set defined time limit wherein the user with the highest bid is given permission to the auctioned parking space.

7. A system of claim 1 wherein the system is configured, in a parking embodiment, to allow for third parties and regional authorities to bid on prices for a selected parking space within a defined region selected by the user wherein the party with the lowest price bid for said parking space within the region will be selected for servicing the user.

8. A system of claim 1 wherein the system is configured, in a parking embodiment, to provide a scaled pre-defined reimbursement to a user for a parking space provided the user relinquishes the parking space during their occupancy upon request from one or more other users for usage of said parking space, and wherein the regional regulatory authority receives a scaled pre-defined portion of the reimbursement.

9. A system of claim 1 wherein one of the services provided allows for one or more notifications to be sent out to the plurality of users with regards to regional services by a regional regulatory authority.

10. A system of claim 1 wherein one of the services provided allows for one or more notifications to be sent out to the regional authorities upon a user utilizing a service at a geographic region prohibited by law for that particular user.

11. A system of claim 1 wherein the system is further configured such that advertisement modules may be inserted into the interface between the plurality of users and the system.

12. A system of claim 11 wherein advertisement may reduce infraction cost by a scaled pre-defined amount upon a user participating in the advertisement.

13. A system of claim 12 wherein the advertisement may be of third party businesses within the region for which the service is being executed for the user.

14. A system for a maximizing vehicular regionally regulated parking revenue comprising:
a plurality of users and enforcement agents which interface with the system for various vehicular regionally regulated services;
one or more vehicular regional regulatory servers configured to allow one or more users and enforcement agents to login, authenticate, and execute selected one or more parking services based on perquisite verification with said platform;
one or more vehicular regional regulatory databases configured to analyze parameters for said one or more vehicular regionally regulated parking services input from the one or more users to correctly administer said services, wherein one parameter is user location; and
an interface to a communication means allowing for communication between said plurality of users, said plurality of enforcement agents, the one or more vehicular regional regulatory servers and one or more vehicular regional databases.

15. A system of claim 14 wherein enforcement agents utilize information from the one or more vehicular regional regulatory databases, in real-time, to determine pending parking expiry.

16. A system of claim 15 wherein enforcement agents utilize said information with a location based algorithm to calculate a most efficient route to navigate to each of said user locations.

17. A system of claim 14 wherein enforcement agents utilize information from the one or more vehicular regional regulatory databases, in real-time, to enforce parking infractions such as ticketing, towing, and clamping.

18. A system of claim 14 wherein upon expiry of a service for a user, the system enforces a penalty onto the user by electronic means.

19. A system of claim 14 wherein notifications are transmitted to enforcement agents upon anomaly in parking space occupancy, wherein parking space occupancy data is collected in the one or more vehicular regional regulatory databases.

20. A system of claim 19 wherein enforcement agents utilize information from the one or more vehicular regional regulatory databases, in real-time, to enforce parking infractions such as ticketing, towing, and clamping.
